(19) United States
(12) Patent Application Publication
(10) Pub. No.: US 2026/0326834 A1
(43) Pub. Date: Oct. 22, 2026

(54) DRIVER CAB KIT SYSTEM AND ASSOCIATED PRODUCTION METHOD

(71) Applicant: MAN Truck & Bus SE, München (DE)

(72) Inventor: Andreas Schmitz, München (DE)

(73) Assignee: MAN Truck & Bus SE, München (DE)

(21) Appl. No.: 19/115,778

(22) PCT Filed: Sep. 21, 2023
(86) PCT No.: PCT/EP2023/076116

§ 371 Date: Mar. 26, 2025

(30) Foreign Application Priority Data
Sep. 27, 2022 (DE) 10 2022 124 761.9

(51) Int. Cl. B62D 33/06; B60J 5/04; B62D 25/04; B62D 25/06; B62D 25/20; B62D 27/02; B62D 65/04

(52) U.S. Cl. CPC B62D 33/06; B60J 5/047; B62D 25/04; B62D 25/06; B62D 25/2018; B62D 27/023; B62D 65/04

(57) ABSTRACT

The present invention concerns, inter alia, an assembly kit system (58) for differently dimensioned driver's cab versions (12A-12E) of a utility vehicle (10). The assembly kit system (58) comprises a front wall (28), which is the same for the different driver's cab versions (12A-12E), a first driver's cab shell construction longitudinal section (30), which is the same for the different driver's cab versions (12A-12E) and widens outwards from the front wall (28) towards the B-pillars (36, 38), and a second driver's cab shell construction longitudinal section (44), which is differently dimensioned version-dependently and widens outwards from the first driver's cab shell construction longitudinal section (30) towards a rear end of the second driver's cab shell construction longitudinal section (44).

The invention concerns an assembly kit system for differently dimensioned driver's cab versions of a driver's cab of a utility vehicle, preferably a truck. The invention also concerns a method for manufacturing a driver's cab of a utility vehicle, preferably a truck.

Aerodynamics are playing an increasingly important role in the design of truck driver's cabs and cabins, respectively. Preferably, the driver's cabs should be relatively narrow at the front. In addition, due to different customer requirements different driver's cab widths are needed, so that a driver's cab portfolio needs narrow and wide driver's cabs. For example, for short driver's cabs rather narrow designs and for longer driver's cabs rather wide designs are desired.

However, the variance in components and production argues against a large driver's cab portfolio with narrow and wide driver's cabs. Traditionally, different widths are used, starting from the front of the driver's cab.

DE 101 18 344 A1 concerns a modularly constructed driver's cab assembly series for trucks for creating driver's cab variants of different length dimensions, with a basic module uniformly constructed for all driver's cab variants and with an add-on module attachable thereto, which comprises different length dimensions for each driver's cab variant. The basic module comprises a front wall, two side walls with door and door frame, a floor and a roof, is designed openly rearwards and has a toroidally closed first flange area at the rear. The add-on module comprises a rear wall, two side wall sections, a floor section and a roof section, is openly frontwards and has a toroidally closed second flange area at the front that complements the first flange area. In the add-on module, the side wall sections, the floor section and the roof section comprise different length measurements for each driver's cab variant.

DE 10 2014 008 631 A1 discloses an assembly kit for a utility vehicle driver's cab with front steering comprising at least a narrow version and a wide version formed with at least the following components enclosing an interior: a front wall, a rear wall, two flat side walls neighbored to the rear wall, and two curved doors with a first connection towards the front wall and a second connection towards the side walls. The narrow version comprises a narrow rear wall and the wide version a wider rear wall compared to the narrow version. Both versions comprise the same front wall, the two flat side walls are oriented perpendicular to the front wall and rear wall. In the narrow version, the two curved doors are oriented at a smaller internal angle to the front wall than in the wide version.

The invention is based on the problem to provide an improved technique for manufacturing different driver's cab versions, preferably using an equal part strategy.

The problem is solved by the features of the independent claims. Advantageous further embodiments are given in the dependent claims and the description.

One aspect of the present disclosure concerns an assembly kit system for differently dimensioned (e.g. wide and/or long) driver's cab versions of driver's cab a utility vehicle, preferably a truck. The assembly kit system comprises a front wall which is the same for the different driver's cab versions. The assembly kit system has a first (e.g. front) driver's cab shell construction longitudinal section, which is the same for the different driver's cab versions, is connectable (e.g. directly) to the front wall, preferably weldable, comprises two opposite B-pillars and widens outwards from the front wall towards the B-pillars, preferably essentially continuously. The assembly kit system comprises a second (e.g. rear) driver's cab shell construction longitudinal section, which is differently dimensioned, preferably long and/or wide, version-dependently, is (e.g. directly) connectable, preferably weldable, to the first driver's cab shell construction longitudinal section for extending the driver's cab rearwards, and widens outwards, preferably substantially continuously, from the first driver's cab shell construction longitudinal section towards a rear end of the second driver's cab shell construction longitudinal section.

Advantageously, the different versions and thus layouts of the driver's cab according to the present disclosure can always originate from the same front width due to the front wall always being the same and then arrow or extend outwards towards the rear wall of the driver's cab. The extension/widening rearwards extends both over the first driver's cab shell construction longitudinal section and the second driver's cab shell construction longitudinal section. The widening can be the same for all versions up to at least the B-pillar, which has proven to be particularly advantageous. Thereby, differently wide driver's cab versions can be created with different driver's cab lengths by means of differently long second driver's cab shell construction longitudinal sections. Because the front wall is narrower than the narrowest driver's cab requires, an assembly kit system emerges from which narrow driver's cabs can also emerge. In addition, wide driver's cabs can also be particularly aerodynamic due to the narrow front.

In one embodiment example, at least two, at least three or at least four differently long and/or wide versions of the second driver's cab shell construction longitudinal section are comprised.

In a preferred further embodiment, the differently long versions of the second driver's cab shell construction longitudinal section are also differently wide.

In a further embodiment example, the second driver's cab shell construction longitudinal section is an end section for a rear end of the driver's cab.

In a further embodiment, the second driver's cab shell construction longitudinal section is connectable to the first driver's cab shell construction longitudinal section (e.g. directly) at the B-pillars or in the region of the B-pillars, and/or the first driver's cab shell construction longitudinal section ends at the two B-pillars.

In one embodiment, the first driver's cab shell construction longitudinal section and the second driver's cab shell construction longitudinal section widen substantially uniformly relative to each other.

In a further embodiment, the second driver's cab shell construction longitudinal section widens outwards differently (far or wide) version-dependently from the first driver's cab shell construction longitudinal section outwards towards a rear end of the second driver's cab shell construction longitudinal section, preferably essentially continuously. Advantageously, this makes it possible to create driver's cabs of different widths.

In a further embodiment, the second driver's cab shell construction longitudinal section comprises a rear wall flange for connecting a rear wall to the second driver's cab shell construction longitudinal section. Preferably, the rear wall flange can comprise a distance from a center longitudinal axis of the second driver's cab shell construction longitudinal section that is the same for the different driver's cab versions. Advantageously, this can achieve that the same rear wall can be used for all versions of the driver's cab.

In one embodiment, the assembly kit system further comprises a rear wall which is the same for the different driver's cab versions and/or which is (e.g. directly) connectable, preferably weldable, to the second driver's cab shell construction longitudinal section (e.g. on the rear wall flange).

In a further embodiment, the second driver's cab shell construction longitudinal section comprises at least one side flap flange (or side wing flange) for connecting at least one side flap (or side wing) to the second driver's cab shell construction longitudinal section. Preferably, the at least one side flap flange can be the same for the different driver's cab versions. Advantageously, this allows the same side flaps to be used for all versions of the driver's cab.

In a further embodiment, the assembly kit system further comprises at least one side flap (or side wing) which is the same for the different driver's cab versions and/or which is (e.g. directly) connectable, preferably attachable, to the second driver's cab shell construction longitudinal section (e.g. at the at least one side flap flange).

In an embodiment example, the first driver's cab shell construction longitudinal section and/or the front wall comprises a door flange for connecting a driver's cab door to the first driver's cab shell construction longitudinal section and/or the front wall. Preferably, the door flange can be the same for the different driver's cab versions. Advantageously, this can achieve that the same driver's cab door can be used for all versions of the driver's cab.

In a further embodiment example, the assembly kit system further comprises a driver's cab door which is the same for the different driver's cab versions and/or which is movably, preferably pivotably, connectable (e.g. directly) to the first driver's cab shell construction longitudinal section and/or the front wall (e.g. on the door flange).

In a further embodiment, the assembly kit system further comprises a driver's cab floor which is differently long version-dependently and/or which is (e.g. directly) connectable, preferably weldable, to the front wall, the first driver's cab shell construction longitudinal section and the second driver's cab shell construction longitudinal section.

In one embodiment, the assembly kit system further comprises a driver's cab roof which is differently long version-dependently and/or that is connectable, preferably weldable, to the first driver's cab shell construction longitudinal section and the second driver's cab shell construction longitudinal section (e.g. directly).

A further aspect of the present disclosure concerns a method for manufacturing a driver's cab of a utility vehicle, preferably a truck. The method comprises manufacturing the driver's cab by means of an assembly kit system as disclosed herein. Advantageously, the method can achieve the same advantages as already explained with reference to the assembly kit system.

The preferred embodiments and features of the invention described above can be combined with each other as desired. Further details and advantages of the invention are described below with reference to the accompanying drawings. Showing:

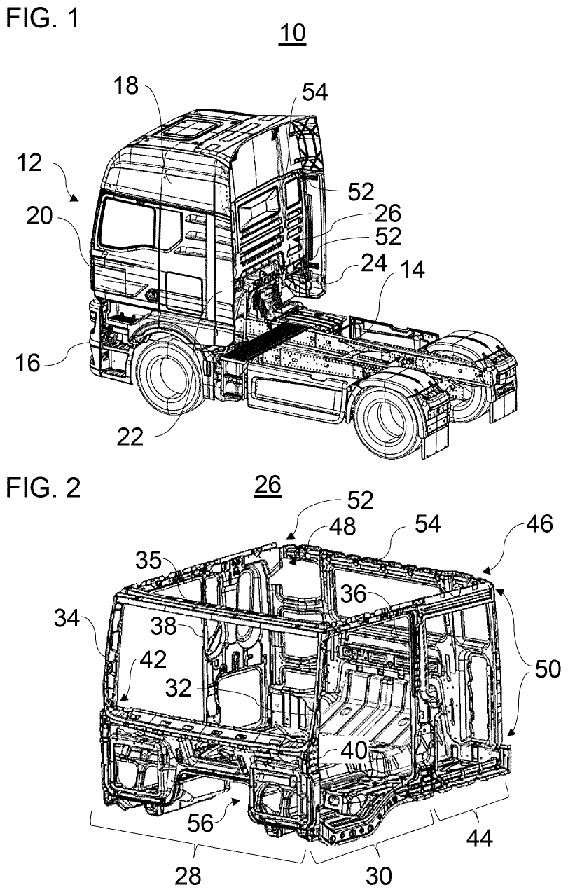

FIG. 1 a perspective view of a utility vehicle;

FIG. 2 a perspective view of a driver's cab shell construction of the utility vehicle;

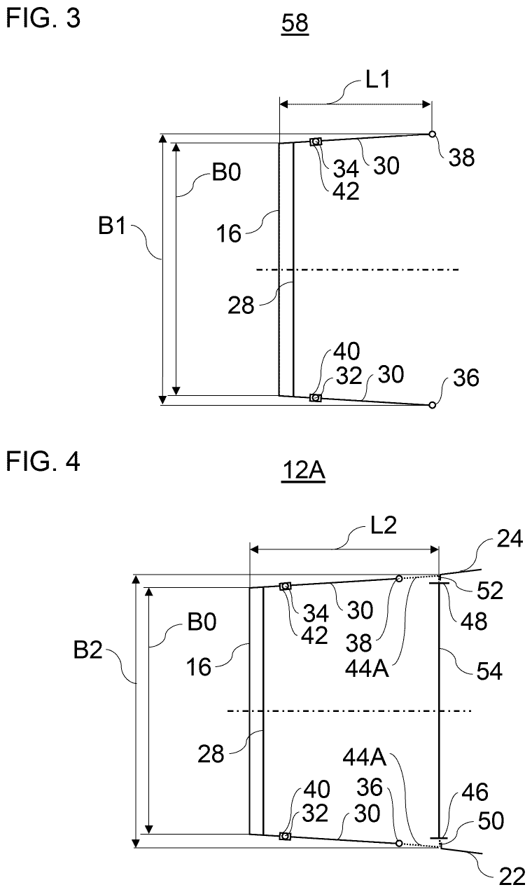

FIG. 3 a schematic cross-section of components of an assembly kit system for a utility vehicle driver's cab or driver's cab shell construction according to an embodiment of the present disclosure; and

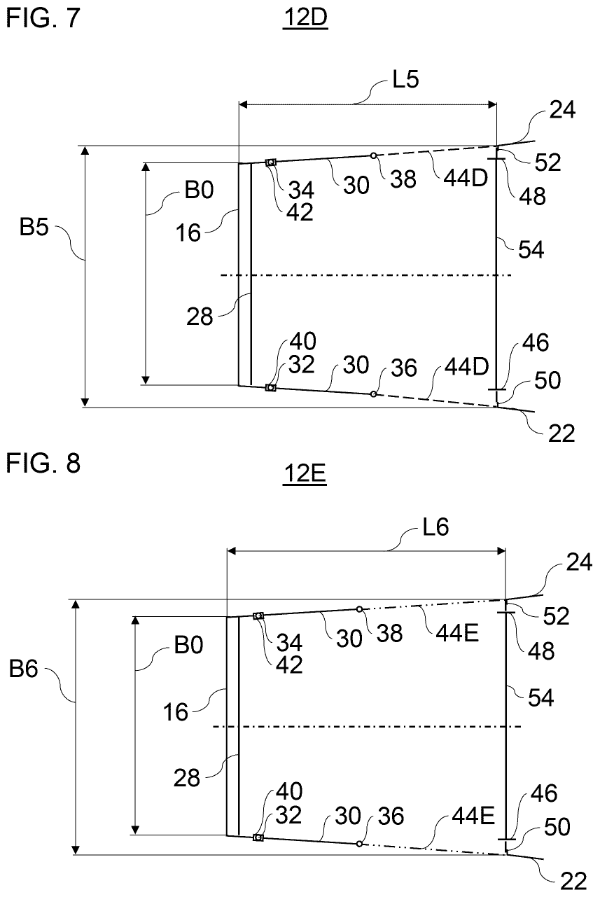

FIGS. 4 to 8 schematic cross-sections of a utility vehicle driver's cab or driver's cab shell construction in different versions created by means of the assembly kit system according to the present disclosure.

The embodiments shown in the figures correspond to each other at least in part, such that similar or equal parts are provided with the same reference signs and reference is also made to the description of the other embodiments or Figures for their explanation in order to avoid repetition.

A particular feature of the present disclosure is an assembly kit system 58 for producing utility vehicle driver's cabs 12 in differently dimensioned versions 12A-12E. The assembly kit system 58 is described herein by way of example with reference to FIG. 3ff. For better understanding, exemplary driver's cabs 12 that can be manufactured using the assembly kit system 58 and utility vehicles 10 with a corresponding driver's cab 12 are first described below with reference to FIGS. 1 and 2.

FIG. 1 shows a utility vehicle 10 with a (utility vehicle) driver's cab 12 comprising a driver's cab shell construction 26.

As shown in FIG. 1, the utility vehicle 10 is preferably designed as a truck. Accordingly, the driver's cab shell construction 26 may preferably be designed as a truck driver's cab shell construction. For example, the truck can be designed as a tractor unit. It is also possible that the truck is modified in such a way that it comprises, for example, a (e.g. loading) body.

The driver's cab 12 or the driver's cab shell construction 26 may be supported on a vehicle frame 14 of the utility vehicle 10, for example sprung and/or damped. The vehicle frame 14 may, for example, be designed as a ladder frame. It is possible that the driver's cab 12 or the driver's cab shell construction 26 can be pivoted with respect to the vehicle frame 14 by means of a tilting or pivoting device, preferably forwards, to provide access to at least one component which is arranged underneath the driver's cab 12 or the driver's cab shell construction 26. This at least one component may, for example, be supported on the vehicle frame 14. This at least one component may comprise, for example, an internal combustion engine, a transmission, an auxiliary unit, a traction battery and/or an electric drive device, etc.

The driver's cab 12 may comprise, for example, a front panel 16, a driver's cab roof 18, at least one driver's cab door 20 and/or at least one side flap and a side wing 22, 24, respectively.

The front panel 16 can cover the driver's cab shell construction 26 at its front. The front panel 16 may, for example, be arranged below a windshield of the driver's cab 12.

The driver's cab roof 18 can cover the driver's cab shell construction 26 from above. The driver's cab roof 18 can extend substantially over the entire driver's cab shell construction 26. It is possible that the driver's cab roof 18 comprises a, preferably pivotable, roof spoiler.

The at least one driver's cab door 20 is preferably pivotably connected to the driver's cab shell construction 26. Preferably, two driver's cab doors 20 are comprised (only one visible in FIG. 1). For example, the at least one driver's cab door 20 may comprise a (e.g. driver's) door on a driver's side of the driver's cab 12 and/or a (e.g. passenger's) door on a passenger's side of the driver's cab 12.

The at least one side flap 22, 24 may be arranged on a rear side of the driver's cab 12. The at least one side flap 22, 24 may be attached to the driver's cab shell construction 26. The at least one side flap 22, 24 may aerodynamically extend the driver's cab 12 rearwards. For example, a first side flap 22 can extend a longitudinal outer side of the driver's cab 12 rearwards. A second side flap 24 can extend a longitudinal outer passenger side of the driver's cab 12 rearwards.

FIG. 2 shows the driver's cab shell construction 26 of the driver's cab 12, which is preferably formed from sheet metal.

The driver's cab shell construction 26 comprises a front wall 28, a first driver's cab shell construction longitudinal section 30 and a second driver's cab shell construction longitudinal section 44. The driver's cab shell construction 26 may further comprise a rear wall 54 and a driver's cab floor 56.

The front wall 28 may form a front end of the driver's cab shell construction 26. The front wall 28 may also be referred to as a so-called firewall. For example, the front wall 28 may comprise an inverted U-shape. The front wall 28 may be oriented transversely to a center longitudinal axis of the driver's cab shell construction 26. The front wall 28 may be disposed below a windshield of the driver's cab 12. The front wall 28 may be covered by the front panel 16 (see FIG. 1). Preferably, the front wall 28 is a sheet metal part. The front wall 28 can extend essentially over an entire front width of the driver's cab shell construction 26.

The first driver's cab shell construction longitudinal section 30 is connected to the front wall 28, preferably by means of welded connection(s). Preferably, the first driver's cab shell construction longitudinal section 30 is connected to opposite ends of the front wall 28. Preferably, the first driver's cab shell construction longitudinal section 30 may be formed from sheet metal.

It is possible that the first driver's cab shell construction longitudinal section 30 comprises the A-pillars 32, 34. Alternatively, the A-pillars 32, 34 can, for example, be formed separately from the first driver's cab shell construction longitudinal section 30 and can, for example, be connected, preferably welded, to the first driver's cab shell construction longitudinal section 30 and/or the front wall 28 when the driver's cab shell construction 26 is joined.

It is also possible that the first driver's cab shell construction longitudinal section 30 comprises a cross member 35 arranged between upper ends of the A-pillars 32, 34. Alternatively, the cross member 35 can, for example, be formed separately from the first driver's cab shell construction longitudinal section 30 and can, for example, be connected, preferably welded, to the first driver's cab shell construction longitudinal section 30 when the driver's cab shell construction 26 is joined.

The first driver's cab shell construction longitudinal section 30 comprises the B-pillars 36, 38. The first B-pillar 36 may be arranged on a driver's side of the driver's cab shell construction 26. The second B-pillar 38 may be arranged on a passenger side of the driver's cab shell construction 26. The B-pillars 36, 38 may be arranged opposite one another. Preferably, the first driver's cab shell construction longitudinal section 30 ends at the B-pillars 36, 38.

Starting from the front wall 28, the first driver's cab shell construction longitudinal section 30 widens outwards towards the B-pillars 36, 38 (transversely to the longitudinal axis of the first driver's cab shell construction longitudinal section 30). The widening is preferably continuous or substantially uniform over a length of the first driver's cab shell construction longitudinal section 30. In other words, the first driver's cab shell construction longitudinal section 30 may taper starting from the B-pillars 36, 38 towards the front wall 28.

Specifically, a driver's side outer contour of the first driver's cab shell construction longitudinal section 30 may lie substantially in a plane that includes an internal angle greater than 90° with a plane in which the front wall 28 lies. A passenger-side outer contour of the first driver's cab shell construction longitudinal section 30 may lie substantially in a plane that includes an internal angle, which is greater than 90°, with a plane in which the front wall 28 lies.

The first driver's cab shell construction longitudinal section 30 may comprise at least one door flange 40, 42. The at least one driver's cab door 20 (see FIG. 1) can be attached to the at least one door flange 40, 42, preferably pivotably. For example, a driver's door 20 (see FIG. 1) can be attached to a driver-side door flange 40. A passenger door can be attached to a passenger-side door flange 42. Alternatively or additionally, the at least one door flange 40, 42 may be included in the front wall 28, for example arranged at outer ends of the front wall 28.

The second driver's cab shell construction longitudinal section 44 is connected to the first driver's cab shell construction longitudinal section 30, preferably by means of welded connection(s). Preferably, the second driver's cab shell construction longitudinal section 44 is connected to the first driver's cab shell construction longitudinal section 30 at or in the region of the B-pillars 36, 38. Preferably, the second driver's cab shell construction longitudinal section 44 can be formed from sheet metal.

The second driver's cab shell construction longitudinal section 44 may extend the driver's cab shell construction 26 rearwards starting from a rear end of the first driver's cab shell construction longitudinal section 30. The second driver's cab shell construction longitudinal section 44 may directly follow the first driver's cab shell construction longitudinal section 30 with respect to a forward driving direction of the utility vehicle 10. The second driver's cab shell construction longitudinal section 44 may be an end section disposed at a rear end of the driver's cab 12 or the driver's cab shell construction 26.

Starting from a rear end of the first driver's cab shell construction longitudinal section 30, the second driver's cab shell construction longitudinal section 44 widens outwards (transversely to the longitudinal axis of the second driver's cab shell construction longitudinal section 44) towards a rear end of the second driver's cab shell construction longitudinal section 44. Preferably, the widening is continuous and substantially uniform over a length of the second driver's cab shell construction longitudinal section 44, respectively. In other words, the second driver's cab shell construction longitudinal section 44 may taper from its rear end towards the first driver's cab shell construction longitudinal section 30.

For example, the driver's cab 12 and the driver's cab shell construction 26 may comprise a sweep across the driver's cab shell construction longitudinal sections 30, 44 with an extension/widening rearwards or a narrowing/taper frontwards. Preferably, a widening of the driver's cab 12 or the driver's cab shell construction 26 may be uniform across the first and second driver's cab shell construction longitudinal sections 30, 44.

Preferably, a plane in which substantially a driver's side outer contour of the second driver's cab shell construction longitudinal section 44 lies may include an interior angle with a plane in which the front wall 28 lies that is greater than 90°. For example, a driver's side outer contour of the second driver's cab shell construction longitudinal section 44 and a driver's side outer contour of the first driver's cab shell construction longitudinal section 30 may lie in substantially the same plane.

Preferably, a plane in which a passenger-side outer contour of the second driver's cab shell construction longitudinal section 44 substantially lies may include an interior angle with a plane in which the front wall 28 lies that is greater than 90°. For example, a passenger-side outer contour of the second driver's cab shell construction longitudinal section 44 and a passenger-side outer contour of the first driver's cab shell construction longitudinal section 30 may lie in substantially the same plane.

The second driver's cab shell construction longitudinal section 44 may comprise at least one rear wall flange 46, 48 for the rear wall 54. The at least one rear wall flange 46, 48 may be disposed at a rear end of the second driver's cab shell construction longitudinal section 44. The at least one rear wall flange 46, 48 may extend interruptedly or uninterruptedly over a substantially entire height of the second driver's cab shell construction longitudinal section 44. The at least one rear wall flange 46, 48 may be oriented in a plane transversely to a center longitudinal axis of the driver's cab 12 or the driver's cab shell construction 26.

The rear wall flange 46 and the rear wall flange 48 may be arranged opposite each other. The rear wall flange 46 may be associated with a driver's side of the second driver's cab shell construction longitudinal section 44. The rear wall flange 48 may be associated with a passenger side of the second driver's cab shell construction longitudinal section 44.

The second driver's cab shell construction longitudinal section 44 may comprise at least one side flap flange 50, 52. The at least one side flap flange 50, 52 may be arranged at a rear end of the second driver's cab shell construction longitudinal section 44. The at least one side flap flange 50, 52 may be oriented in a plane transversely to a center longitudinal axis of the driver's cab 12 or the driver's cab shell construction 26.

The side flap flange 50 may be associated with a driver's side of the second driver's cab shell construction longitudinal section 44. The side flap 22 (see FIG. 1) can be detachably attached to the side flap flange 50, e.g. in a fixed or pivotable manner. The side flap flange 52 may be associated with a passenger side of the second driver's cab shell construction longitudinal section 44. The side flap 24 (see FIG. 1) may be detachably attached to the side flap flange 52, e.g. in a fixed or pivotable manner.

The rear wall 54 may be connected to the rear wall flange 46, 48, preferably by means of welded connection(s). The rear wall 54 may be disposed between the rear wall flange 46 and the rear wall flange 48.

The driver's cab floor 56 may delimit the driver's cab shell construction 26 on the floor side. The driver's cab floor 56 may be connected to the front wall 28, the first driver's cab shell construction longitudinal section 30, the second driver's cab shell construction longitudinal section 44 and/or the rear wall 54, preferably by means of welded connection(s).

FIG. 3 shows purely schematically components of an assembly kit system 58 according to an embodiment example of the present disclosure. As mentioned above, a special feature of the assembly kit system 58 is that it advantageously enables the construction of differently dimensioned versions 12A-12E of the driver's cab 12 and/or the driver's cab shell construction 26, wherein the different versions comprise some equal parts.

Specifically, the assembly kit system 58 comprises the front wall 28 and the first driver's cab shell construction longitudinal section 30. The front wall 28 is the same or an equal part for all different versions of the driver's cab shell construction 26 or the driver's cab 12. The first driver's cab shell construction longitudinal section 30 is the same, or an equal part, for all different versions of the driver's cab shell construction 26 or the driver's cab 12. Consequently, the front wall 28 and the first driver's cab shell construction longitudinal section 30 can form, so to say, a basic or base module that is the same across all versions.

As can be understood from FIG. 3, each driver's cab shell construction 26 derived/created from the assembly kit system 58 comprises a widening from front to rearwards. The widening may be substantially continuous and/or uniform. The widening may be in the form of an arrowing (longitudinal section of an arrow shape).

More specifically, the front panel 16 and/or the front wall 28 comprises, for example, a width B0 measured with respect to a transverse axis of the driver's cab 12 and/or the driver's cab shell construction 26. A rear end of the first driver's cab shell construction longitudinal section 30 comprises a width B1, which is measured with respect to a transverse axis of the driver's cab 12 and/or the driver's cab shell construction 26. The width B1 is greater than the width B0. The first driver's cab shell construction longitudinal section 30 thus widens starting from the front wall 28 towards a rear end of the first driver's cab shell construction longitudinal section 30, e.g. the B-pillars 36, 38. A common length L1 of the front wall 28 and the first driver's cab shell construction longitudinal section 30 can preferably extend as far as the B-pillars 36, 38.

FIGS. 4 to 8 show, by way of example, a first driver's cab version 12A, a second driver's cab version 12B, a third driver's cab version 12C, a fourth driver's cab version 12D and a fifth driver's cab version 12E. The driver's cab versions 12A-12E each comprise the front wall 28, the first driver's cab shell construction longitudinal section 30 and a respective version of the second driver's cab shell construction longitudinal section 44A-44E. The second driver's cab shell construction longitudinal sections 44A-44E are differently dimensioned version-dependently. In addition, the driver's cab versions 12A-12E can each comprise, for example, the front panel 16, the rear wall 54 and/or the side flaps 22, 24.

As can be understood from FIGS. 4 to 8, the driver's cab versions 12A-12E comprise a, preferably substantially continuous and/or uniform, widening from front to rearwards. The widening can be designed as an arrowing (longitudinal section of an arrow shape).

More specifically, the respective width B2 to B6 at a rear end of the respective second driver's cab shell construction longitudinal section 44A-44E is greater than the width B0 and greater than the width B1 (see FIG. 3). The driver's cab versions 12A-12E thus each widen starting from the front wall 28 towards a rear end of the respective second driver's cab shell construction longitudinal section 44A-44E, which may, for example, end at the rear wall 54.

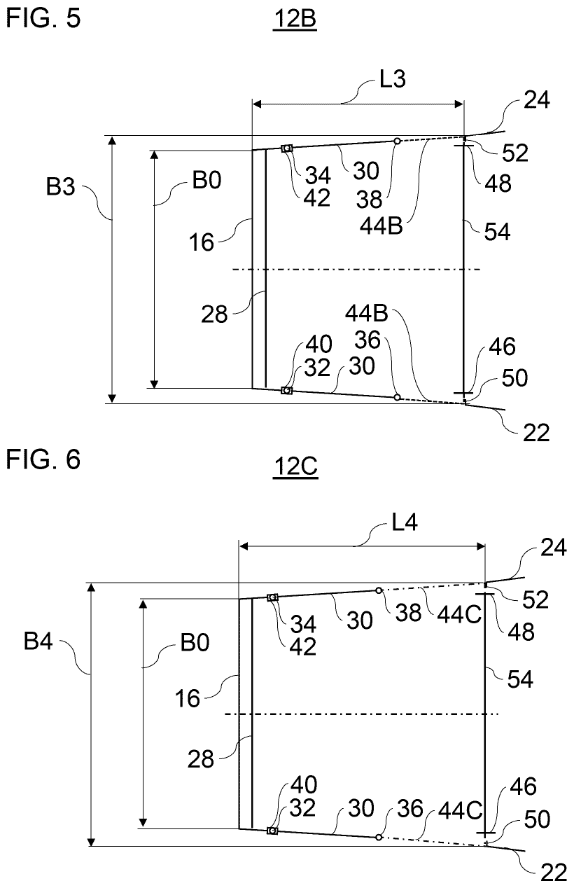

The second driver's cab shell construction longitudinal sections 44A-44E, and thus the driver's cab versions 12A-12E, may be differently long. For example, the second driver's cab shell construction longitudinal section 44A and thus the driver's cab 12A may be shorter than the second driver's cab shell construction longitudinal section 44B and thus the driver's cab 12B (see FIGS. 4 and 5). The second driver's cab shell construction longitudinal section 44B, and thus the driver's cab 12B, may be shorter than the second driver's cab shell construction longitudinal section 44C, and thus the driver's cab 12C (see FIGS. 5 and 6), and so on.

The driver's cab shell construction longitudinal sections 44A-44E may, for example, widen differently due to their different lengths L2-L6. For example, a width B2 of the rear end of the second driver's cab shell construction longitudinal section 44A and thus of the driver's cab 12A may be less wide than a width B3 of the rear end of the second driver's cab shell construction longitudinal section 44B and thus of the driver's cab 12B (see FIGS. 4 and 5). A width B3 of the rear end of the second driver's cab shell construction longitudinal section 44B, and thus of the driver's cab 12B, may be less wide than a width B4 of the rear end of the second driver's cab shell construction longitudinal section 44C, and thus of the driver's cab 12C (see FIGS. 5 and 6), and so on.

FIGS. 4 to 8 thus show several differently long and differently wide versions 44A-44E of the second driver's cab shell construction longitudinal section 44.

Preferably, all driver's cab versions 12A-12E comprise the same rear wall 54. This can preferably be enabled by the rear wall 54 being connectable, preferably weldable, to the different versions 44A-44E of the second driver's cab shell construction longitudinal section 44 via the rear wall flange 46, 48. In turn, the rear wall flange 46, 48 may be of the same design for all versions 44A-44E of the second driver's cab shell construction longitudinal section 44. In particular, the rear wall flange 46, 48 may comprise an equal distance (y-distance or distance in lateral direction of the driver's cab) from a center longitudinal axis of the second driver's cab shell construction longitudinal section 44A-44E for all versions 44A-44E of the second driver's cab shell construction longitudinal section 44.

Preferably, all or at least some of the driver's cab versions 12A-12E may comprise the same side flaps 22, 24. This can preferably be enabled by the fact that the side flaps 22, 24 are connectable, preferably attachable, to the different versions 44A-44E of the second driver's cab shell construction longitudinal section 44 via the side flap flanges 50, 52. In turn, the side flap flanges 50, 52 can be designed identically for all versions 44A-44E of the second driver's cab shell construction longitudinal section 44.

It is possible that all driver's cab versions 12A-12E comprise the same driver's cab doors 20. This can preferably be made possible by the driver's cab doors 20 being connectable, preferably pivotable, to the first driver's cab shell construction longitudinal section 30 designed as an equal part and/or to the front wall 28 designed as an equal part via its at least one door flange 40, 42.

It is also possible that the assembly kit system 58 comprises versions of the driver's cab floor 56 and/or the driver's cab roof 18 of different lengths, depending on a version 12A-12E of the driver's cab 12 and thus depending on a version 44A-44E of the second driver's cab shell construction longitudinal section 44.

The invention is not limited to the preferred embodiments described above. Rather, a large number of variants and modifications are possible which also make use of the inventive concept and therefore fall within the scope of protection. In particular, the invention also claims protection for the subject matter and the features of the dependent claims independently of the claims referred to. In particular, the individual features of independent claim 1 are each disclosed independently of one another. In addition, the features of the sub-claims are also disclosed independently of all the features of independent claim 1 and, for example, independently of the features relating to the presence and/or configuration of the front wall, the first driver's cab shell construction longitudinal section and/or the second driver's cab shell construction longitudinal section of independent claim 1.

Reference sign list

| | |
|---|---|
| 10 | Utility vehicle |
| 12 | Driver's cab |
| 12A | First driver's cab version |
| 12B | Second driver's cab version |
| 12C | Third driver's cab version |
| 12D | Fourth driver's cab version |
| 12E | Fifth driver's cab version |
| 14 | Vehicle frame |
| 16 | Front panel |
| 18 | Driver's cab roof |
| 20 | Driver's cab door |
| 22 | Side flap |
| 24 | Side flap |
| 26 | Driver's cab shell construction |
| 28 | Front wall |
| 30 | First driver's cab shell |
| | construction longitudinal section |
| 32 | A-pillar |
| 34 | A-pillar |
| 35 | Cross member |
| 36 | B-pillar |
| 38 | B-pillar |
| 40 | Door flange |
| 42 | Door flange |
| 44 | Second driver's cab shell |
| | construction longitudinal section |
| 44A | First version of the second |
| | driver's cab shell construction |
| | longitudinal section |
| 44B | Second version of the second |
| | driver's cab shell construction |
| | longitudinal section |
| 44C | Third version of the second |
| | driver's cab shell construction |
| | longitudinal section |
| 44D | Fourth version of the second |
| | driver's cab shell construction |
| | longitudinal section |
| 44E | Fifth version of the second |
| | driver's cab shell construction |
| | longitudinal section |
| 46 | Rear wall flange |
| 48 | Rear wall flange |
| 50 | Side flap flange |
| 52 | Side flap flange |
| 54 | Rear wall |
| 56 | Driver's cab floor |
| 58 | Assembly kit system |
| Bx | Width |
| Lx | Length |

1-15. (canceled)

16. An assembly kit system for differently dimensioned driver's cab versions of a driver's cab of a utility vehicle, comprising:
a front wall, which is the same for the different driver's cab versions;
a first driver's cab shell construction longitudinal section, which:
is the same for the different driver's cab versions;
is connectable to the front wall;
comprises two opposite B-pillars; and
widens outwards from the front wall to the B-pillars; and
a second driver's cab shell construction longitudinal section, which:
is differently dimensioned version-dependently,
is connectable to the first driver's cab shell construction longitudinal section for extending the driver's cab rearwards, and
widens outwards from the first driver's cab shell construction longitudinal section towards a rear end of the second driver's cab shell construction longitudinal section.

17. The assembly kit system according to claim 16, wherein:
the utility vehicle is a truck;
the first driver's cab shell construction longitudinal section is weldable to the front wall;
the first driver's cab shell construction longitudinal section widens outwards essentially constantly;
the second driver's cab shell construction longitudinal section is differently dimensioned, namely long and/or wide;
the second driver's cab shell construction longitudinal section is weldable to the first driver's cab shell construction longitudinal section for extending the driver's cab rearwards; or
the second driver's cab shell construction longitudinal section widens outwards essentially constantly.

18. The assembly kit system according to claim 16, wherein:
at least two, at least three or at least four differently long and/or differently wide versions of the second driver's cab shell construction longitudinal section are comprised.

19. The assembly kit system according to claim 16, wherein:
the second driver's cab shell construction longitudinal section is an end section for a rear end of the driver's cab.

20. The assembly kit system according to claim 16, wherein:
the second driver's cab shell construction longitudinal section is connectable to the first driver's cab shell construction longitudinal section at the B-pillars or in the region of the B-pillars; and/or
the first driver's cab shell construction longitudinal section ends at the two B-pillars.

21. The assembly kit system according to claim 16, wherein:
the first driver's cab shell construction longitudinal section and the second driver's cab shell construction longitudinal section widen substantially uniformly with respect to each other.

22. The assembly kit system according to claim 16, wherein:
the second driver's cab shell construction longitudinal section widens outwardly differently wide version-dependently from the first driver's cab shell construction longitudinal section towards a rear end of the second driver's cab shell construction longitudinal section.

23. The assembly kit system according to claim 16, wherein:
the second driver's cab shell construction longitudinal section comprises a rear wall flange for connecting a rear wall to the second driver's cab shell construction longitudinal section; and
the rear wall flange comprises a distance from a center longitudinal axis of the second driver's cab shell construction longitudinal section which is the same for the different driver's cab versions.

24. The assembly kit system according to claim 16, further comprising:
a rear wall, which:
is the same for the different driver's cab versions, and
is connectable to the second driver's cab shell construction longitudinal section.

25. The assembly kit system according to claim 16, wherein:
the second driver's cab shell construction longitudinal section comprises at least one side flap flange for connecting at least one side flap to the second driver's cab shell construction longitudinal section; and
the at least one side flap flange is the same for the different driver's cab versions.

26. The assembly kit system according to claim 16, further comprising:
at least one side flap, which:
is the same for the different driver's cab versions, and
is connectable to the second driver's cab shell construction longitudinal section.

27. The assembly kit system according to claim 16, wherein:
the first driver's cab shell construction longitudinal section and/or the front wall comprises a door flange for connecting a driver's cab door to the first driver's cab shell construction longitudinal section and/or the front wall; and
the door flange is the same for the different driver's cab versions.

28. The assembly kit system according to claim 16, further comprising:
a driver's cab door, which:
is the same for the different driver's cab versions, and
is movably connectable to the first driver's cab shell construction longitudinal section and/or the front wall.

29. The assembly kit system according to claim 16, further comprising:
a driver's cab floor, which
is differently long version-dependently; and
is connectable to the front wall, the first driver's cab shell construction longitudinal section and the second driver's cab shell construction longitudinal section.

30. The assembly kit system according to claim 16, further comprising:
a driver's cab roof, which:
is differently long version-dependently; and
is connectable to the first driver's cab shell construction longitudinal section and the second driver's cab shell construction longitudinal section.

31. The assembly kit system according to claim 16, wherein:
the second driver's cab shell construction longitudinal section widens outwardly substantially continuously;
at least one side flap is attachable to the second driver's cab shell construction longitudinal section; or
a driver's cab door is pivotably connectable to the first driver's cab shell construction longitudinal section and/or the front wall.

32. The assembly kit system according to claim 16, wherein:
a rear wall is weldable to the second driver's cab shell construction longitudinal section;
a driver's cab floor is weldable to the front wall, the first driver's cab shell construction longitudinal section and the second driver's cab shell construction longitudinal section; or
a driver's cab roof is weldable to the first driver's cab shell construction longitudinal section and the second driver's cab shell construction longitudinal section.

33. A method for manufacturing a driver's cab of a utility vehicle, comprising:
manufacturing the driver's cab by means of an assembly kit system according to claim 16.

34. The method of claim 33, wherein the utility vehicle is a truck.
